(19) United States
(12) Patent Application Publication
(10) Pub. No.: US 2020/0032791 A1
(43) Pub. Date: Jan. 30, 2020

(54) SPRING STRUCTURE WITH SLIDING ELEMENT

(71) Applicant: GM GLOBAL TECHNOLOGY OPERATIONS LLC, Detroit, MI (US)

(72) Inventors: Andy Bennett, SR., Rochester Hills, MI (US); Anthony Anzalone, Royal Oak, MI (US); Bryan K. Pryor, Waterford, MI (US)

(21) Appl. No.: 16/043,814

(22) Filed: Jul. 24, 2018

(51) Int. Cl. F04C 14/22; F04C 2/344; F16F 1/12

(52) U.S. Cl. CPC F04C 14/22; F01M 1/02; F16F 1/12; F04C 2/3442

(57) ABSTRACT

Variable displacement pumps and biasing assemblies for the same are disclosed. Example pumps may include a housing having an inlet and an outlet, and a rotor fixed for rotation with a shaft, with the shaft rotatably mounted within the housing. The pump may further include a plurality of radially extending vanes slidably disposed in the rotor, and a pivotable ring member defining a control chamber about the rotor, with the ring member being pivotable within the housing to vary an eccentricity of the ring member with respect to the rotor. The pump may further include a biasing assembly applying a biasing force to the ring member in a first direction about the shaft, with the biasing assembly including at least one resilient element extending longitudinally along a stand, and a sliding support slidably disposed on the stand and laterally supporting the resilient element with respect to the stand.

### INTRODUCTION

Variable displacement oil pumps may employ a rotatable ring member or slide within a housing, which facilitates a change in pump displacement by way of varying an eccentricity of the slide with respect to a pump rotor. The pivotable slide may be biased in a given direction about the axis of the rotor with a spring. The slide may be pivoted to a desired position corresponding to a desired displacement of the pump.

Known biasing elements employ a spring mounted on a stand, which aligns the spring between the slide and the housing. The stand typically contacts the spring periodically during use, especially where the spring is relatively elongated. Contact between the spring and stand may cause wear to the spring and/or stand, which may contaminate the oil and, in some cases, lead to failure of the spring or other internal components of the pump. The expected contact between the spring and stand, both of which are typically formed of a metal material, also imposes design requirements on the spring and stand, e.g., to ensure compatibility of the materials for contact with each other. Moreover, current stand designs fail to adequately prevent buckling of the spring, especially if the spring is relatively elongated.

Accordingly, there is a need for an improved pump that addresses the above shortcomings.

### SUMMARY

In at least some example approaches, a variable displacement pump may include a housing having an inlet and an outlet, and a rotor fixed for rotation with a shaft, with the shaft rotatably mounted within the housing. The pump may further include a plurality of radially extending vanes slidably disposed in the rotor, and a pivotable ring member defining a control chamber about the rotor, with the ring member being pivotable within the housing to vary an eccentricity of the ring member with respect to the rotor. The pump may further include a biasing assembly applying a biasing force to the ring member in a first direction about the shaft, with the biasing assembly including at least one resilient element extending longitudinally along a stand, and a sliding support slidably disposed on the stand and laterally supporting the resilient element with respect to the stand.

In at least some example approaches, the at least one resilient element includes a coil spring. In some examples, the at least one resilient element includes two separate resilient elements connected by the sliding support. The two separate resilient elements may each have a same spring rate or may have different spring rates. The two separate resilient elements may, in some example approaches, both have linear spring rates. In one example, the two separate resilient elements are both coil springs.

In some approaches, the sliding support may define first and second opposing support surfaces for the two resilient elements, respectively, e.g., where the two resilient elements are first and second coil springs. The sliding support may also have a plurality of axially extending tabs retaining the first and second coil springs to the first and second opposing support surfaces, respectively.

In some examples, the stand of the pump may be supported on the housing at a first end of the at least one resilient element, with a second or opposite end of the at least one resilient element contacting a radially extending lever of the ring member, thereby biasing the ring member in the first direction.

In other examples, the stand of the pump may be supported on a radially extending lever of the ring member. In these examples, the stand may define a first curved surface contacting a second curved surface defined by the radially extending lever. In some example approaches the first and second curved surfaces are each spherical.

In some examples, the stand includes a cylindrical body extending axially along the at least one resilient element.

Some example approaches to a sliding support may delimit radial movement of the at least one resilient element with respect to the stand.

In another example of a variable displacement pump, the pump includes a housing having an inlet and an outlet, and a rotor fixed for rotation with a shaft, with the shaft rotatably mounted within the housing. The pump may further include a plurality of radially extending vanes slidably disposed in the rotor, and a pivotable ring member defining a control chamber about the rotor, with the ring member being pivotable within the housing to vary an eccentricity of the ring member with respect to the rotor. The pump may further include a biasing assembly applying a biasing force to the ring member in a first direction about the shaft. The biasing assembly may include two separate coil springs extending longitudinally along a stand, and a sliding support connecting the coil springs, with the sliding support slidably disposed on the stand and laterally supporting each of the coil springs with respect to the stand.

In some of these examples, the sliding support defines first and second opposing support surfaces for the first and second coil springs, respectively, and a plurality of axially extending tabs retaining the first and second coil springs to the first and second opposing support surfaces, respectively.

In some approaches, the stand may be supported on the housing at a first end of the at least one resilient element, a second end of the at least one resilient element being opposite the first end and contacting a radially extending lever of the ring member, thereby biasing the ring member in the first direction.

In other example approaches, the stand may be supported on a radially extending lever of the ring member. In some such examples, the stand may define a first curved surface contacting a second curved surface defined by the radially extending lever.

Example illustrations are also directed to a biasing assembly for a variable displacement pump. The pump may have a housing defining an inlet and an outlet, a rotor fixed for rotation with a shaft, the shaft rotatably mounted within the housing, a plurality of radially extending vanes slidably disposed in the rotor, and a pivotable ring member defining a control chamber about the rotor, with the ring member being pivotable within the housing to vary an eccentricity of the ring member with respect to the rotor. The biasing assembly may be configured to apply a biasing force to the ring member in a first direction about the shaft. The biasing assembly may include two separate coil springs extending longitudinally along a stand, and a sliding support connecting the coil springs. The sliding support may be slidably disposed on the stand and laterally support each of the coil springs with respect to the stand.

### BRIEF DESCRIPTION OF THE DRAWINGS

One or more embodiments of the invention will hereinafter be described in conjunction with the appended drawings, wherein like designations denote like elements, and wherein:

FIG. 1A is a partial cutaway view of a variable displacement oil pump having a biasing element with an example sliding element for a spring structure;

FIG. 1B is an assembly view of the spring structure of FIG. 1B, according to one example approach;

FIG. 1C is a perspective view of the sliding element of FIGS. 1A and 1B, according to an example; and

FIG. 2 is a partial cutaway view of a variable displacement oil pump having a biasing element with a sliding element for a spring structure, according to an example approach.

### DETAILED DESCRIPTION

Exemplary systems and methods are provided herein for a biasing assembly for a pump, such as a variable displacement pump. Example biasing assemblies may provide support to one or more biasing elements, e.g., springs, coil springs, flexible bellows, or any other resilient element capable of providing a spring force. As will be described further below, example biasing assemblies may provide lateral support to one or more longitudinally extending resilient elements by way of a sliding support, thereby increasing durability of the biasing assemblies. A pump employing an example biasing assembly may thereby be provided with improved durability and reduced overall weight amongst other advantages, which will be described further below.

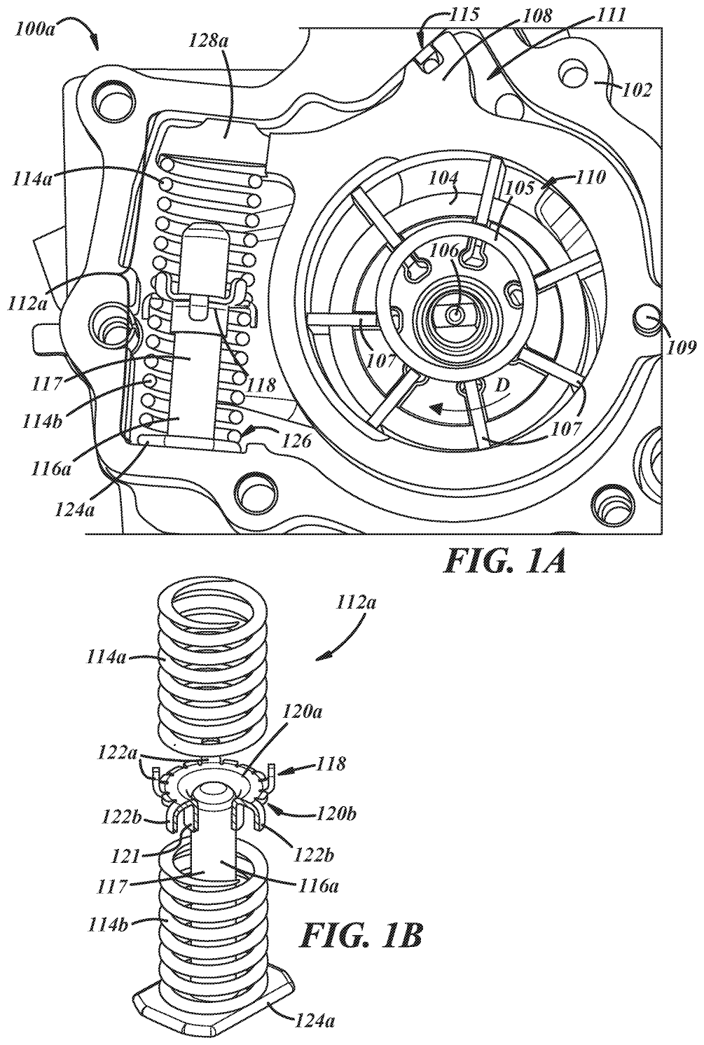

Turning now to FIGS. 1A, 1B and 1C, an example variable displacement pump 100a is illustrated. The pump 100a may include a housing 102 having an inlet and an outlet (not shown in FIG. 1A). The pump 100a may further include a rotor 104 that is fixed for rotation with a shaft 106. The shaft 106 may be rotatably mounted within the housing 102. The housing 102 may be an intermediate housing of an assembly forming a housing for the pump 100a. A plurality of radially extending vanes 107 may be slidably disposed in the rotor 104. A pivotable ring member 108 defines a control chamber 110 about the rotor 104. The ring member 108 may be pivotable within the housing 102, facilitating the varying of displacement output by way of altering an eccentricity of the ring member 108 with respect to the rotor 104.

The pump 100a also includes a biasing assembly 112a. The biasing assembly 112a may apply a biasing force to the ring member 108 in a first direction D about the shaft 106. The biasing assembly 112a may include at least one resilient element 114 extending longitudinally along a stand 116. The biasing assembly 112a may further include a sliding support 118 which is slidably disposed on the stand 116 and, as will be described further below, laterally supports the resilient element 114 with respect to the stand 116. The stand 116 and sliding support 118 may be formed of any material that is convenient, e.g., a metallic material such as steel or aluminum.

The biasing assembly 112a may generally be used to control displacement of the pump 100a by way of positioning the ring member 108, along with other forces applied selectively to the ring member 108. More specifically, as seen in FIG. 1A, the ring element 108 may be eccentric with respect to the rotor 104. The ring member 108 is pivotable about a pivot 109. The pivot 109 may be provided by any mechanism that is convenient, e.g., a dowel pin or the like. A plurality of vanes 107 are radially slidable in the rotor 107. A vane ring 105 may control the radial position of the vanes 107 within the rotor 104. Each of the vanes 107 contact the ring member 108 at a radially outermost end of the vane 107, and as such the ring member 108 generally controls the radial position of each of the vanes 107 with respect to the rotor 104. When the rotor 104 turns during operation, pressure builds within a chamber 110 of the pump 100a that is defined at least in part by the adjacent vanes 107, the rotor 104, and the ring member 108. Pressure builds within the chamber 110 as the rotor 104 turns, due to the volume restriction placed upon the chamber 110 by the ring member 108. The internal pressure that builds within the chamber 110 applies a torque to the ring member 108. The biasing assembly 112a may also apply a torque to the ring member 108 by biasing the ring member 108 in a first direction (clockwise in FIG. 1A, as indicated by arrow D). Additionally, external pressure may be applied to the ring member by a control chamber 111 to counteract the torque from the chamber 110 and/or the biasing force applied by the biasing assembly 112a. The control chamber 111 may be defined at least in part by the housing 102 and the ring member 108. A slide seal 115 of the ring member 108 may facilitate buildup of pressure within the control chamber 111 by generally sealing between the ring member 108 and housing 102 as the ring member 108 pivots about the pivot 109, with the slide seal 115 sliding along the housing 102. The control chamber 111 may receive pressure, for example, from a return line (not shown) of an engine associated with the pump 100a. When the ring member 108 is rotated to a position where it is concentric with respect to the rotor 104, the output of the pump 100a is zero displacement, as there is no difference in volume between the control chamber 110 and an exit port of the pump 100a. By contrast, output displacement of the pump 100a is generally maximized when the ring member 108 is positioned at its greatest degree of eccentricity with respect to the rotor 104. As the external pressure applied to the ring member 108 may be controlled independently of the speed of the rotor 104, the external pressure may be modified during operation to position the ring member 108 (in opposition to the torque applied by the biasing assembly 112a and/or the internal pressure of the control chamber 110) to obtain a desired displacement output.

As noted above, the biasing assembly 112a may include one or more resilient elements, e.g., springs, configured to apply a biasing force to the ring member 108. In the example illustrated in FIGS. 1A-1C, the biasing assembly includes two separate coil springs 114a, 114b. The coil springs 114a, 114b are joined by a slide support 118. The slide support 118 may include a cylindrical body 121 defining a bore 119. The cylindrical body 121 of the slide support 118 is configured to slide axially along a cylindrical body 117 of the stand 116a. The coil springs 114a and 114b are each retained against respective support surfaces 120a, 120b. For example, the slide support 118 may include axially extending tabs 122a, 122b, which may delimit radial movement of the springs 114a, 114b, or even be wrapped around the springs 114a, 114b. Radial movement of the slide support 118 is generally prevented by the cylindrical body 121 being limited to longitudinal or axial movement along the cylindrical body 117 of the stand 116a. Accordingly, each of the springs 114a, 114b are substantially prevented from contacting the stand 116a.

In the example illustrated in FIGS. 1A and 1B, the stand 116a is generally supported by an internal support surface 126 of the housing 102. For example, the stand 116a may have a base 124a which rests upon the internal support surface 126, such that the internal support surface 126 provides a reaction surface for the biasing assembly 112a when the biasing assembly 112a is under compression. Thus, in the example illustrated in FIGS. 1A and 1B, the internal support surface 126 may provide a reaction surface for a first end of the resilient element of the biasing assembly 112a (i.e., the end of the coil spring 114b nearest surface 126) within the housing 102. A second end of the resilient element of the biasing assembly 112a opposite the first end may contact a lever 128a of the ring member 108. The lever 128a is generally fixed with the ring member 108 (and may be formed as a unitary part with the ring member 108) and extends radially away from the ring member 108. As such, the end of coil spring 114a contacting lever 128a may provide compression force from the combined assembly of the springs 114a and 114b and the slide support 118. The biasing assembly 112a may thereby generally apply a biasing force to the ring member 108 in the first direction D.

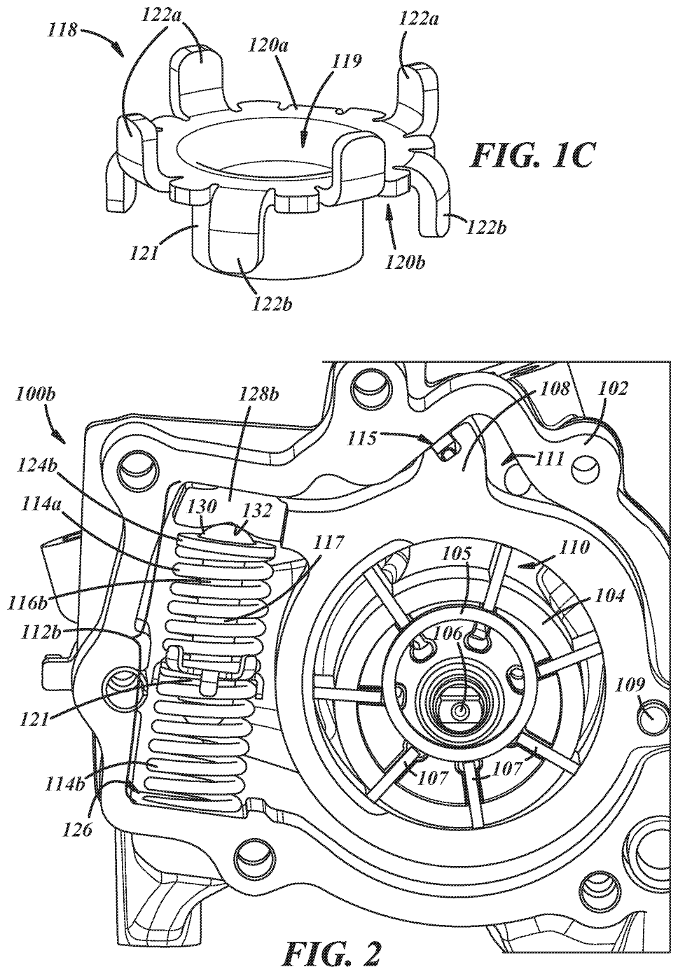

Turning now to FIG. 2, another example biasing assembly 112b is illustrated in a variable displacement pump 100b. While the pump 100b is otherwise identical to pump 100a, in the example of FIG. 2, the biasing assembly 112b is supported at the opposite end of the resilient element assembly, i.e., at a radially extending lever 128b of the ring element 108.

More specifically, the biasing assembly 112b is supported upon a stand 116b having a base 124b. The base 124b defines a spherical or curved surface 130, which contacts a complementary spherical or curved surface 132 defined by the lever 128b. The cylindrical body 121 of the slide support 118 slides longitudinally or axially along the cylindrical body 117 of the stand 116b, and the slide support 118 retains the adjacent ends of the springs 114a and 114b by way of the tabs 122a, 122b, respectively. Thus, radial movement of the springs 114a, 114b is restricted in substantially identical manner as that described above in the example of FIGS. 1A and 1B.

The mating curved surfaces 130, 132 of the stand 116b and lever 128b, respectively, may advantageously allow for the stand 116b to maintain appropriate alignment of the biasing assembly 112b between the internal support surface 126 of the housing 102 and the lever 128b. More specifically, when the ring member 108 is pivoted about the pivot 109, the lever 128b may shift laterally by a relatively small distance (i.e., in a direction parallel to the support surface 126). The curved surfaces 130, 132 allow the biasing assembly 112b to swivel or tilt slightly with respect to the lever 128b to accommodate this shift. Additionally, the opposite end of the biasing assembly 112b may maintain a relatively normal position with respect to the internal support surface 126 of the housing. In one example, the end of the spring 114b contacting the internal support surface 126 may be ground flat, or otherwise oriented normal to the internal support surface 126. The secure retention of each end of the biasing assembly 112b (i.e., at the lever 128b and the internal support surface 126) within the pump 100b may increase robustness and durability of the pump 100b, e.g., by further reducing likelihood of lateral shifting or buckling of the springs 114a/114b.

Example biasing assemblies 112a, 112b (collectively, 112) may employ any type or configuration of resilient elements that is convenient, as noted above. In the coil spring examples provided herein, the coil springs 114a, 114b may have identical spring rates, or may have different spring rates. Example spring rates may be linear or non-linear. In examples where the coil springs 114a, 114b have different spring rates, an overall spring rate of the biasing assembly 112 may thereby vary over a total length of compression of the biasing assembly 112. Merely by way of example, if coil spring 114a is provided with a greater spring rate than the coil spring 114b, the overall spring rate of the biasing assembly 112 may initially be relatively low (as a function of the spring rates of both of the springs 114a, 114b), and then become relatively greater upon maximum compression of the coil spring 114b (as the coil spring 114b is at that point essentially solid, such that the spring rate is substantially equal to that of the coil spring 114a alone).

A progressive overall spring rate of the biasing assembly may allow greater efficiency of an engine employing pumps 100a/100b as an oil pump. More specifically, at lower engine speeds, demand for oil pressure is not as great. Thus, an initially lower overall spring rate of the biasing assembly 112 permits a greater range of movement of the ring element 108. At higher engine speeds where internal pressures are greater within the pump 100a, 100b, the relatively greater spring rate may prevent the biasing assembly 112 from being maximally compressed, or otherwise able to withstand higher pressures/forces within the pump 100a, 100b.

Example biasing assemblies 112 may generally prevent buckling of the resilient elements employed therein. For example, by limiting (or even prohibiting entirely) radial movement of the coil springs 114a, 114b with respect to the stand 116, the coil springs 114a, 114b remain aligned axially with the stand 116. The springs 114a, 114b may thus have relatively larger aspect ratios (i.e., ratio of spring diameter to spring length). While previous approaches to biasing assemblies would risk buckling at aspect ratios at 50% or below, the slide support 118 generally permits any aspect ratio to be used that is convenient. The reduced risk of spring buckling results in corresponding reductions in failure of the pumps 100a, 100b.

Additionally, as the slide support 118 essentially prevents springs 114a, 114b from contacting the stand 116, material compatibility issues between the springs 114a, 114b and the stand are avoided. Accordingly, different materials (e.g., having different hardnesses) of the springs 114a, 114b, and the stand 116 may be used. Additionally, to any extent advanced materials or treatments would otherwise be necessary in the coil springs 114a, 114b or stand 116, e.g., heat treatment due to expectation of contact between the spring(s) 114 and stand 116), such materials/treatments are not necessary in the example biasing assemblies 112 due to the expected lack of any contact between the spring(s) 114 and stand 116 due to radial relative movement between these components. Thus, relatively simple forming processes (e.g., stamping, punching, etc.) may be employed to form the stand 116. Additionally, assembly of the example pumps 100a, 100b remains relatively simple, as the slide support 118 and springs 114a, 114b may be preassembled by using the tabs 122a, 122b to form a preassembled resilient element, which is then assembled onto the stand 116.

In some extreme cases, contact between springs 114a/114b and the stand 116 may result in material scrap entering the oil flow, causing leakage or damage within the pump 100. Thus, the reduction in contact between the spring(s) 114a/114b and the stand 116 resulting from the lateral support provided by the slide support 118 may reduce oil consumption, to the extent the reduction or elimination in contact between the springs 114a, 114b and the stand 116 prevents such leakage or damage. In other words, reduced wear of the spring(s) 114a/114b and the stand 116 in turn reduces the amount and likelihood of material from the spring(s) 114a/114b and stand 116 being shaved off and entering the oil flow. This reduction in material loss results in a corresponding reduction in internal damage to the pumps 100a, 100b over time.

The example biasing assemblies 112 may also reduce weight and cost of the pumps 100a, 100b. For example, due to the increased robustness of the biasing assemblies 112 with respect to maintaining alignment of the resilient element(s) within a pump, a relatively short (axially) stand 116 may be employed. In other words, as the slide support 118 has primary responsibility for interacting with and guiding the coil springs 114a, 114b, the stand 116 may be relatively short compared with the overall length of the biasing assembly 112. Additionally, the reduction or elimination of contact between the springs 114a/114b and the stand 116 reduces or eliminates the need to select materials that are compatible for contact with each other and allows the use of lighter weight materials.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A variable displacement pump, comprising:
a housing having an inlet and an outlet;
a rotor fixed for rotation with a shaft, the shaft rotatably mounted within the housing;
a plurality of radially extending vanes slidably disposed in the rotor;
a pivotable ring member defining at least in part a control chamber about the rotor, wherein the ring member is pivotable within the housing to vary an eccentricity of the ring member with respect to the rotor; and
a biasing assembly applying a biasing force to the ring member in a first direction about the shaft, the biasing assembly including at least one resilient element extending longitudinally along a stand, and a sliding support slidably disposed on the stand and laterally supporting the resilient element with respect to the stand.

2. The variable displacement pump of claim 1, wherein the at least one resilient element includes two separate resilient elements connected by the sliding support.

3. The variable displacement pump of claim 2, wherein the two separate resilient elements each have a same spring rate.

4. The variable displacement pump of claim 2, wherein the two separate resilient elements have different spring rates.

5. The variable displacement pump of claim 2, wherein the two separate resilient elements each have linear spring rates.

6. The variable displacement pump of claim 2, wherein the two separate resilient elements are first and second coil springs.

7. The variable displacement pump of claim 6, wherein the sliding support defines first and second opposing support surfaces for the first and second coil springs, respectively, and a plurality of axially extending tabs retaining the first and second coil springs to the first and second opposing support surfaces, respectively.

8. The variable displacement pump of claim 1, wherein the at least one resilient element includes a coil spring.

9. The variable displacement pump of claim 1, wherein the stand is supported on the housing at a first end of the at least one resilient element, a second end of the at least one resilient element being opposite the first end and contacting a radially extending lever of the ring member, thereby biasing the ring member in the first direction.

10. The variable displacement pump of claim 1, wherein the stand is supported on a radially extending lever of the ring member.

11. The variable displacement pump of claim 10, wherein the stand defines a first curved surface contacting a second curved surface defined by the radially extending lever.

12. The variable displacement pump of claim 11, wherein the first and second curved surfaces are each spherical.

13. The variable displacement pump of claim 1, wherein the stand includes a cylindrical body extending axially along the at least one resilient element.

14. The variable displacement pump of claim 1, wherein the sliding support delimits radial movement of the at least one resilient element with respect to the stand.

15. A variable displacement pump, comprising:
a housing having an inlet and an outlet;
a rotor fixed for rotation with a shaft, the shaft rotatably mounted within the housing;
a plurality of radially extending vanes slidably disposed in the rotor;
a pivotable ring member defining at least in part a control chamber about the rotor, wherein the ring member is pivotable within the housing to vary an eccentricity of the ring member with respect to the rotor; and
a biasing assembly applying a biasing force to the ring member in a first direction about the shaft, the biasing assembly including two separate coil springs extending longitudinally along a stand, and a sliding support connecting the coil springs, the sliding support slidably disposed on the stand and laterally supporting each of the coil springs with respect to the stand.

16. The variable displacement pump of claim 15, wherein the sliding support defines first and second opposing support surfaces for the first and second coil springs, respectively, and a plurality of axially extending tabs retaining the first and second coil springs to the first and second opposing support surfaces, respectively.

17. The variable displacement pump of claim 1, wherein the stand is supported on the housing at a first end of the at least one resilient element, a second end of the at least one resilient element being opposite the first end and contacting a radially extending lever of the ring member, thereby biasing the ring member in the first direction.

18. The variable displacement pump of claim 1, wherein the stand is supported on a radially extending lever of the ring member.

19. The variable displacement pump of claim 18, wherein the stand defines a first curved surface contacting a second curved surface defined by the radially extending lever.

20. A biasing assembly for a variable displacement pump having a housing defining an inlet and an outlet, a rotor fixed for rotation with a shaft, the shaft rotatably mounted within the housing, a plurality of radially extending vanes slidably disposed in the rotor, and a pivotable ring member defining at least in part a control chamber about the rotor, wherein the ring member is pivotable within the housing to vary an eccentricity of the ring member with respect to the rotor, the biasing assembly comprising:
two separate coil springs extending longitudinally along a stand; and
a sliding support connecting the coil springs, the sliding support slidably disposed on the stand and laterally supporting each of the coil springs with respect to the stand;
wherein the biasing assembly is configured to apply a biasing force from the coil springs to the ring member in a first direction about the shaft.
